(19) United States
(12) Patent Application Publication
(10) Pub. No.: US 2013/0290143 A1
(43) Pub. Date: Oct. 31, 2013

(54) LOAN SYNDICATION MARKETPLACE

(71) Applicant: LOAN STREET LLC, (US)

(72) Inventors: Ian A. LAMPL, Washington, DC (US); Chris WU, New York, NY (US)

(21) Appl. No.: 13/853,370

(22) Filed: Mar. 29, 2013

Related U.S. Application Data
(60) Provisional application No. 61/618,113, filed on Mar. 30, 2012.

(51) Int. Cl. G06Q 30/06; G06Q 40/08

(52) U.S. Cl. CPC G06Q 30/06; G06Q 40/08
USPC 705/26.63; 705/38

(57) ABSTRACT

Methods and systems of loan syndication are provided. Upload details of an originated loan owned by a user may be stored in a database. The database is queried and results are presented to an investor so that the investor can determine if he wishes to purchase either at least a portion of a single loan or portion of a portfolio of loans. The database returns a list of loans or a portfolios of loans that satisfy the investor's search criteria, wherein the loan results that are returned are owned by an entity other than the investor. The investor is able to select a loan for purchase from the list in order for ownership of the selected loan to transfer from the owning entity an entity associated with the investor.

### CROSS-REFERENCE TO RELATED APPLICATIONS

This application claims priority to U.S. Provisional Patent Application No. 61/618,113 filed on Mar. 30, 2012, which is hereby incorporated herein in its entirety.

### BACKGROUND

A syndicated loan, whether by assignment, participation or other means, is one that is provided by a group of lenders and is structured, arranged, and administered by one or several commercial banks or investment banks known as arrangers. The existing loan syndication market tends to exclude the syndication of smaller sized loans because their syndication is generally cost prohibitive. Furthermore, smaller lending institutions, such as small banks, credit unions and loan funds, tend to originate smaller sized loans which can result in smaller lending institutions holding the entire principal amount (less any amortization) of their loans from origination until final repayment by the borrower. Holding the entire principal amount of these loans until repayment can result in smaller lending institutions having a greater concentration of assets, including in terms of borrowers, geography, loan types and even business sector than may otherwise be optimal and inhibits lending by smaller lending institutions because the capital that would otherwise be available to lend, if a portion of the principal amount of those loans could be syndicated, is locked in existing loans. Additionally, this lack of syndication of smaller loans results in the inability of investors to have access to small loans as an asset class, reducing their ability to diversify their investments.

In order to syndicate smaller loans, a cost-effective means of syndication is necessary. Syndicating smaller loans would result in greater diversification of assets for loan originators, greater overall lending to borrowers and create a new asset class for investors.

### SUMMARY OF INVENTION

Embodiments of the invention create a system for facilitating the syndication of loans by assignment, participation or other means. Whether the purchase of a portion of a loan is in the form of an assignment, participation or by other means is not a limitation on the invention. The system provides a means for a loan originator to upload the details of a loan for syndication to a database. For each uploaded loan, the system allows the loan originator to manage the potential investors of the loans in each loan by selecting which group of investors may purchase a portion of a loan. Investors, in an embodiment of the invention, comprising other loan originators and investors, would then search the database by means of an algorithm using certain metrics, including the terms of the loans and details regarding the loan originators to purchase either a portion of a single loan or portions of a fund or basket of various loans. If seeking to create a basket of loans, the investor may also be able to select concentration and maximum position limits for individual loans in the basket of loans, for example limiting the amount of loans from a single loan originator or loan type. With the investor chosen search terms, an algorithm runs on the database using the requested search terms and returns to the investors either a list of individual loans or a series of basket of loans that satisfy the search criteria depending on whether an individual loan or a basket of loans is requested. These searchable metrics would allow the investor to purchase a portion of a loan or a basket of portions of loans that met its requirements for the underlying loans and the loan originators. These searches can also act as a form of due diligence by enabling the investor to limit the purchase of loans to institutions that meet its desired metrics.

Upon purchase, the investor would transfer money to each applicable loan originator via a third party entity for the portion of any loan purchased. Thereafter, when a loan originator receives money from a borrower such as interest or principal with respect to a loan that has been syndicated on the system, the loan originator will transfer the proportion of the payment conforming to the portion of the loan that has been purchased to the investors.

In an embodiment of the system, a secondary market would be available allowing investors to sell previously purchased loans, basket of loans, or combinations of different baskets and individual loans to other investors thereby facilitating the creation of a secondary market.

To facilitate the transfer of funds from loan originators to investors and from investors to loan originators, the system of a third party entity may manage the membership of the syndicate, i.e., the investors who have purchased a portion of a loan, and facilitate the distribution of payments between the parties. In addition to facilitating the transfer of funds, the system also may uses the syndicate membership information to facilitate other actions that may be taken over the course of the loan, including voting by syndicate members of certain amendments that may need to occur from time to time with respect to the loan documents between the originating lender and the borrower.

According to one aspect, a method of loan syndication is provided. Upload details of an originated loan owned by a user may be stored in a database. The database is queried and results are presented to an investor so that the investor can determine if he wishes to purchase either at least a portion of a single loan or a basket of portfolio of portions of loans. The database returns a list of loans or a series of portfolios of loans that satisfy the investor's search criteria, wherein the loan results that are returned are owned by an entity other than the investor. The investor is able to select a loan for purchase from the list in order for ownership of the selected loan to transfer from the owning entity an entity associated with the investor.

According to another aspect, another method of loan syndication is provided. The method may include: receiving an indication from a user that the user wishes to list a loan or portfolio of loans for sale on a server over a network; determining, by a computing device using a database, whether the user is an investor or a loan originator; presenting options to the user to post at least a portion of the loan or portfolio of loans for sell on the server; receiving a selection of one of the options from the user; receiving the at least a portion of the loan or portfolio of loans that the user wishes to sell using the server; publishing, using the server, the at least a portion of the loan or portfolio of loans that the user has to sell; and receiving a purchase request from an investor to purchase the at least a portion of the loan or portfolio of loans that the server published for sale.

According to yet another aspect, a system for loan syndication is provided. The system may include: a database communicatively connected to a computing device over a network; a server communicatively connected to the computing device over the network; and a module, when executed by a processor on the server causes the server to perform a method. The performed method may include: receiving upload details of an originated loan; storing the upload details in the database; receiving query terms from a user to query the database so that a user can determine if the user wishes to purchase either at least a portion of a single loan or portions of a portfolio of loans; querying the database with the requested query terms and returning a list of loans or a portfolios of loans that satisfy the search criteria and that are owned by an entity other than the user; and receiving a selection of a selected loan from the user so that the user can purchase the selected loan in order for ownership of the selected loan to transfer from the owning entity an entity associated with the user.

### BRIEF DESCRIPTION OF DRAWINGS

Aspects of the present invention is further described in the detailed description which follows in reference to the noted plurality of drawings by way of non-limiting examples of embodiments of the present invention in which like reference numerals represent similar parts throughout the several views of the drawings and wherein:

FIGS. 1, 2 & 3 collectively illustrate a flowchart of a method for a syndication of a loan and an example of a secondary market for syndicated loans in accordance with an embodiment of the present invention.

FIG. 4 is a block schematic diagram of an example of a system for a loan participation market in accordance with an embodiment of the present invention.

FIG. 5 illustrates a graphical user interface (“GUI”) of an aspect of an example of a method for a syndication of a loan and an example of a secondary market for syndicated loans in accordance with an embodiment of the present invention.

FIG. 6 illustrates another GUI illustrating another aspect of an example of a method for a syndication of a loan and an example of a secondary market for syndicated loans in accordance with an embodiment of the present invention.

FIG. 7 illustrates another GUI illustrating another aspect of an example of a method for a syndication of a loan and an example of a secondary market for syndicated loans in accordance with an embodiment of the present invention.

FIG. 8 illustrates another GUI illustrating another aspect of an example of a method for a syndication of a loan and an example of a secondary market for syndicated loans in accordance with an embodiment of the present invention.

FIG. 9 illustrates another GUI illustrating another aspect of an example of a method for a syndication of a loan and an example of a secondary market for syndicated loans in accordance with an embodiment of the present invention.

FIG. 10 illustrates another GUI illustrating another aspect of an example of a method for a syndication of a loan and an example of a secondary market for syndicated loans in accordance with an embodiment of the present invention.

FIG. 11 illustrates another GUI illustrating another aspect of an example of a method for a syndication of a loan and an example of a secondary market for syndicated loans in accordance with an embodiment of the present invention.

FIG. 12 illustrates another GUI illustrating another aspect of an example of a method for a syndication of a loan and an example of a secondary market for syndicated loans in accordance with an embodiment of the present invention.

FIG. 13 illustrates another GUI illustrating another aspect of an example of a method for a syndication of a loan and an example of a secondary market for syndicated loans in accordance with an embodiment of the present invention.

FIG. 14 illustrates another GUI illustrating another aspect of an example of a method for a syndication of a loan and an example of a secondary market for syndicated loans in accordance with an embodiment of the present invention.

FIG. 15 illustrates another GUI illustrating another aspect of an example of a method for a syndication of a loan and an example of a secondary market for syndicated loans in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As used herein, a class may define an abstract characteristic of a thing or object, such as a group of code or instructions for performing a particular operation or function. The abstract characteristics may include characteristics of the thing or object, for example attributes, fields or properties, behaviors, such as functions or methods that can be performed by the class. An object is a particular instance of a class. The set of values of the attributes of a particular object is the state of the object. The object includes the state and the behavior that is defined in the object's class. A method is an object's abilities or functions the object can perform.

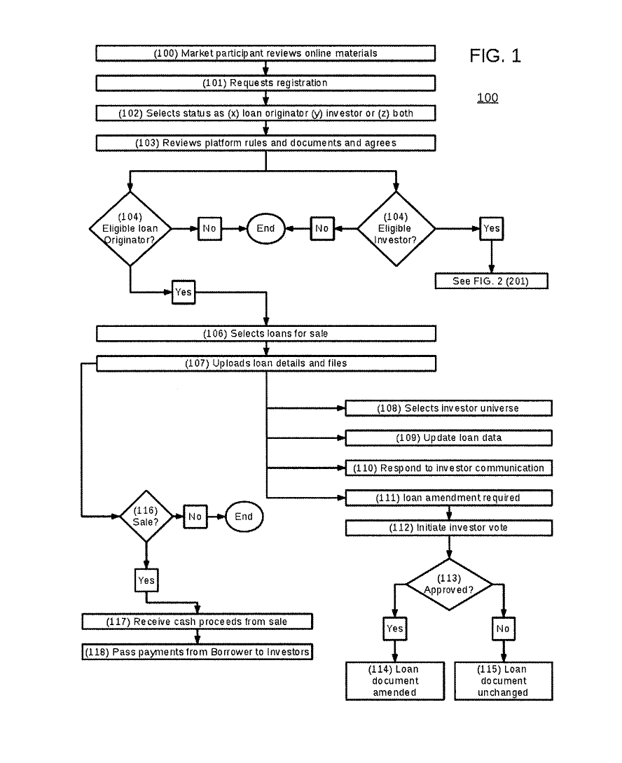

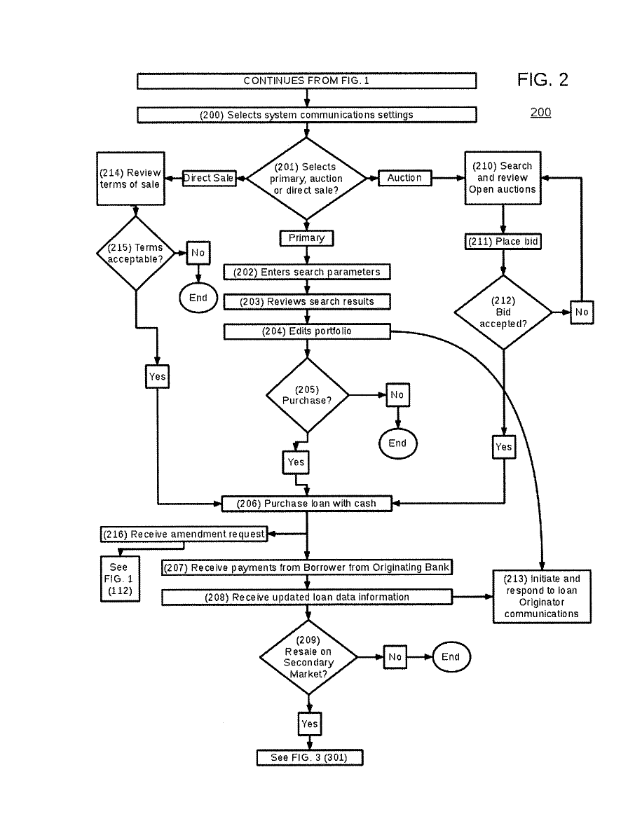

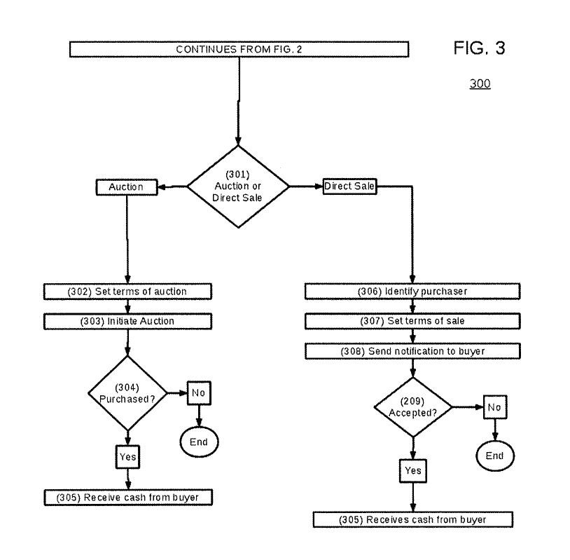

FIGS. 1, 2 & 3 collectively illustrate a block schematic diagram of an example of a method for a syndication of a loan and an example of a secondary market for syndicated loans in accordance with an embodiment of the present invention. Various aspects of such embodiment are discussed below. It should be understood that the terms “loan” may refer to a single loan or a portion of a single loan, while the terms “basket of loans”, “portfolio of loans” or “loans” may refer to a plurality of single loans and/or a plurality portions of loans which may be syndicated loans. Additionally, it should be understood that there may be at least four parties: a loan originator, owners of the loan (which could be called investors herein), an investor interested in buying at least a portion of the loan, and a third party. The loan originator originates the loan and may or may not be a current owner of a portion of the loan. The third party is not a loan originator or one of the investors on the loan but instead acts as an intermediary between parties as discussed below with regard to FIGS. 1-3. Additionally, the term “system,” as used herein, refers to a computing system or the like of the third party.

Block 100 of FIG. 1 illustrates potential market participants reviewing informational materials about the system to determine whether to register and participate in the system as a loan originator, an investor or both. The information materials include, among other matters, a description of the system as well as a description of eligible market participants comprising of investors and loan originators. In an embodiment of the invention, eligible loan originators include organizations in the business of making loans to individuals and businesses although the organization need not be solely or even primarily engaged in the business of making loans and investors would include any eligible loan originator and any other organization interested in investing in the loans issued by the eligible loan originators. Examples of eligible loan originators include state-chartered banks and examples of eligible investors, in addition to eligible loan originators, include sophisticated investors such as Qualified Intuitional Buyers, or QIBs, and while an embodiment of the system may limit eligible investors to a certain level of sophistication, such a limitation is not required by the present invention. Moreover, while the provision of informational materials may be useful in soliciting loan originators and investors, the provision of such information is not required by the present invention.

Block 101 illustrates potential market participants requesting registration to join the system. In an embodiment of the invention, a potential market participant could make a request to register with the system by accessing the registration portion of the system through a network, supplying the information to the system which evidences their status as an eligible loan originator or investor, and then submitting that information to the system over the network. The system will then receive the registration information and register that individual/company while saving the information in a database. While, in one embodiment of the invention, a registration process is used to limit potential market participants, such limitations are not required by the present invention.

Block 102 illustrates the potential market participant selecting to register with the system as a loan originator, investor or both. This may occur during the registration process of block 101. In this regard, during the course of registering with the system, a potential market participant may identify themselves for the system, by submitting that information to the system by means of a network, whether she intended to register as a loan originator, an investor or both. In this regard, the system would register the market participant as selected (i.e., a loan originator, an investor or both). While, in an embodiment of the invention, a registration process is used to limit and identify the type of potential market participants, such limitations are not required by the present invention.

Block 103 illustrates the potential market participant reviewing system materials and agreements to determine whether to submit a registration request to the system. During the registration process with the system, the system provides, by means of the network, the system's terms of use, a standard agreement(s) which will govern the syndication of the loan from the loan originator to the investor, and other information and agreements that may support the syndication of the loans on the system. While in an embodiment of the invention, a registration process is used to limit potential market participants, such limitations are not required by the present invention.

The system then determines at decision blocks 104 and/or 105 whether the market participant can join as a loan originator and/or an investor. In this regard, decision block 104 shows the system making a determination as to whether a potential market participant that registers as a loan originator is eligible to join the system as a loan originator. In an embodiment of the invention, for example, an eligible loan originator such as state-chartered bank, after submitting information evidencing its status as an eligible loan originator, the system, either manually through review by an administrator of the system or through an automated means, would review the information to confirm eligibility and confirm the availability of a login and password to allow future access to the loan originator to the system. While in an embodiment of the invention, a registration process is used to limit potential market participants, such limitations are not required by the present invention. If the loan originator is determined to be eligible, the method may continue to block 106, discussed later. However, if the loan originator is determined to not be eligible, the method may end or proceed to block 105 if the participant indicated that he is both a loan originator and an investor.

Decision block 105 shows a determination as to whether a potential market participant choosing to register as an investor is eligible to join the system as an investor. In an embodiment of the invention, for example, an eligible investor such as a “qualified institutional buyer,” after submitting information evidencing its status as an eligible investor, the system, either manually through review of the submission by an administrator of the system or through some means of automation, would review the information to confirm eligibility and confirm the availability of a login and password to allow future access to the investor to the system. This may be accomplished by reviewing a database of approved investors or requiring the participant to provide credentials evidencing investor status. While in an embodiment of the invention, a registration process is used to limit potential market participants, such limitations are not required by the present invention. If the participant is determined to be an eligible investor, the method may continue to block 201 at FIG. 2, discussed later. However, if the participant is determined to not be an eligible investor, the method may end.

In blocks 106-118, the method may perform steps in response to determining that the participant is an eligible loan originator. Likewise, in FIG. 2, the method may perform steps in response to determining that the participant is an eligible investor. It should be understood that the steps of FIG. 2 and blocks 106-118 may both occur since a participant may be both an eligible, system-registered loan originator and an eligible, system-registered investor. In one embodiment, each of the steps of 107-118 are performed by the third party using the third party's computing system to allow for the third party to manage the auction sale, proceeds from the sale, proceeds received as principal and interest payments, and amending loan documentation. Blocks 106-118 are discussed below first.

Block 106 illustrates a system-registered loan originator reviewing its issued loans for purposes of selecting loans to syndicate on the system. For example, an eligible loan originator may make a loan to a business to purchase capital equipment and will hold that loan as an asset without having previously sold or syndicated any portion of it to any other institution. This eligible loan is then uploaded to the system so that one or more portions of the loan may be sold or syndicated. In this regard, a loan originator selects the loans which may be uploaded to the system's database.

When the loans have been selected, in block 107, the system-registered loan originator uploads the loan information to the system, by means of the network. This information may include any information about the loan, including the details and files of a selected loan. In one embodiment, the system-registered loan originator indicates the principal amount available for syndication for each loan being uploaded to the system. In an embodiment of the invention, the system would limit the maximum principal amount that a loan originator would be permitted to syndicate such as no more than 75% of the principal amount of a loan and thereby require the loan originator to continue to hold at least 25% of the principal amount of a loan. In another embodiment of the invention, the loan originator could, as part of the process of uploading the loan details, set its own maximum syndication amount for each loan which could be the entire loan. Regardless, other information that may be provided to the system would be who the loan originator is, the total loan principal amount, the principal amount of the loan to be syndicated, any collateral or property that acts as security for the loan, the borrower of the loan, the industry of the borrower business, if applicable, and/or any other information relating to the loan such as, among other matters, the type of loan, the interest rate and type, maturity, origination date, form of amortization, if any, and principal amount. After all of the details of the selected loans have been provided by the loan originator, the system then receives the information and creates and stores the information in one or more database entries in the system's database for future access (including querying).

Block 108 illustrates a system-registered loan originator determining the universe of system-registered investors who may participate in the syndication of the loan. This information is provided to the third party's system and is associated with the respective loan as determined by the loan originator. The universe of investors would consist of all system-registered investors and within that set of potential investors, a loan originator could choose to deny certain investors the ability to purchase a particular loan. For example, a loan originator may choose to select that all eligible investors have the ability to purchase the loan from it; the loan originator could specify which investors are allowed to purchase by selecting a small group of investors (and thereby excluding all others); or the loan originator could limit the eligible investors by, for example, making a lists of system-registered investors, and informing the system that a particular list of system-registered investors should not have the ability to purchase any portion of a particular loan from the loan originator. While in an embodiment of the invention, loan originators are able to limit potential investors, such limitations are not required by the present invention.

Block 109 illustrates a system-registered loan originator, by using the means of a network, uploads to the third party's system the loan files, such as the executed loan agreement and other ancillary agreements including a security agreement, a guaranty agreement, borrower specific information such as the borrower's financial statements (which may have been used by the loan originator for purposes of conducting due diligence on the borrower before making the loan), or other documents, whereby such documents and files sometimes referred to as a “loan file”. This “loan file” could be updated from time to time by the third party as necessary for the loan originator to update the members of the syndicate information regarding the loan documents, the borrower or any other information applicable to that loan. In an embodiment of the invention, the loan originator would separately identify for the third party's system, by submitting the information over the network, specific details about the loan such as, among other matters, the type of loan, the interest rate and type, maturity, origination date, form of amortization, if any, and principal amount or in another embodiment of the invention, the system may automate the collection of such information by means of reviewing the uploaded loan file. In another embodiment of the invention, the third party's system would gather the information, details of the loan and the loan file directly from the loan originator's information technology systems. For example, a loan originator may store the loan file and details of the loan, such as interest type and rate, origination date, maturity, principal amount, payment schedules, amortization among other items, in an information technology system, sometimes referred to as a loan management system or a bank's “core” system, and, in one embodiment of the invention, this information would be automatically retrieved directly from that information technology system by means of a network once a person associated with the loan originator identifies a particular loan for syndication rather than having an individual associated with the loan originator manually uploading that information to a database for syndication. The manner in which the information regarding the loan and the loan file are provided to the third party's system is not a limitation on the present invention.

Block 110 illustrates a system-registered loan originator responding to system-registered investor communications regarding a particular uploaded loan. For example, a system-registered investor may, from time to time, choose to submit to the third party's system questions regarding the details of an uploaded loan. The loan originator may choose to respond to such questions on the third party's system by, for example, means of posting a text-based communication similar to a message board. This allows investors to obtain more information rather than just the information posted on the third party's system. In an embodiment of the invention, each loan, in addition to having details about the loan available for review on the third party's system, may also provide investors the ability to post questions and receive answers from loan originators, similar to a message board, that would be connected to the loan so that anytime a market participant were to review that loan it could also review any previous loan originator-investor communications associated with that loan. While an embodiment of the invention allows for loan originator-investor communications, the ability to communicate in such a fashion is not a limitation on the present invention.

Block 111 illustrates a system-registered loan originator determining that an amendment, or some other action, requiring a vote of the syndicate members is required, as determined by the agreements governing the relationship between the investors and the loan originator. Additionally, the third party's system indicates to investors whether a vote of the investors who have purchased a portion of the loan is being prepared to be initiated. This allows the investors to be notified via the third party's system of votes, amendments and any other changes to the syndicated loans that they own, as well as notifying potential investors of amendments, potential amendments, votes and any other information regarding the investment that may be of interest to potential investors. The notifications can be performed electronically as messages to an inbox or can be posted on the website of the third party's system according to some embodiments.

Block 112 illustrates a system-registered loan originator initiating a vote of the investors in a particular loan. The legal agreement governing relationship between the loan originator and investor will govern the voting rules, including the percentage of approval required. Once a vote occurs, the loan may be changed in some way, including terms of the loan. As such, potential investors may be interested in knowing such vote and/or, depending on the legal agreements governing, the vote of the investors may be required.

Decision block 113 illustrates the third party's system providing the originating lender information about the vote of the investors in order to determine whether the action requiring syndicate member/investor voting had passed. In an embodiment, the third party's system would calculate on behalf of the originating lender whether the amendment had passed or failed.

Block 114 and 115 illustrates the end result of a vote by a syndicate (e.g., a collection of investors and/or loan originators that own at least a portion of a loan) resulting in either the action subject to the vote being passed or failing. In block 115, the change was not approved and thus, the syndicated loan has not been changed. As such, no change to the loan documents may be made by the third party's system. In one embodiment, the third party's system records that the vote occurred and was not approved. In block 116, if the change is approved, the loan document is amended. Approved amendments are then marked as such in the third party's database and displayed to potential investors and to current investors.

Referring back to block 116, a determination of whether a sale has occurred. As mentioned above, system-registered investors may participate in a syndication of the loan by purchasing a portion of an uploaded loan which would result in the system-registered loan originator receiving money from the system-registered investor for the portion of the loan purchased on the system. For example, from time to time, once a loan has been uploaded to the system, a system-registered investor may purchase either the full amount, or a portion, such as 10%, of the principal amount available for syndication, of the loan. If the investor has purchased a portion or the full amount of the principal amount available, then it is determined that a sale has occurred and the method continues to block 117.

Block 117 illustrates the system-registered loan originator receiving the proceeds from the syndication of a portion of a loan, on the system from a system-registered investor. The system receiving the sale proceeds is one that is a system of a third party (i.e., a party other than the loan originator or investors). In this regard, a third party manages the transfer of money from the purchaser to the loan originator. The transfer of proceeds may be submitted to the third party's system in any manner. For example, the amount purchased may be transferred on the system by an “Automated Clearing House” (“ACH”) payment or by other means. In an embodiment of the invention, when a purchase occurs, the system of the third party charges a commission or fixed fee for the purchase which would result in either the loan originator receiving the amount purchased less the commission or fixed fee or the investor being charged that amount to conduct the purchase. The commission amount may be transferred to the operator of the system. In another embodiment of the system, the users, either the loan originators, the investors or both, of the system could be charged a subscription fee either in addition to or in lieu of a commission for access to the system.

Block 118 illustrates the system-registered loan originator transferring money such as the principal and/or interest paid by a borrower on a syndicated loan to the system-registered investors (via the third party's system) who have purchased a portion of the loan on the system. This transfer of money could occur by ACH or other means. In an embodiment of the system, the loan originator would notify the third party's system that a borrower payment had occurred, and the third party's system would then transfer the money from an account designated by the loan originator to accounts designated by each investor who own the loan or portions thereof. In another embodiment, the third party's system would periodically review whether a borrower payment had occurred by accessing a loan originator's information systems and, if a borrower payment had occurred, would transfer the money from the account designated by the loan originators to accounts designated by each investor.

As mentioned previously with regard to block 104, if an investor is determined to be an eligible investor, the steps of FIG. 2 may be performed starting with block 200. In this regard, FIG. 2 illustrates an exemplary process of an investor interacting with the third party's system. As such, block 200 continues from block 105 and illustrates a system-registered investor selecting the communications settings for the system such as, for example, requesting to be informed by the system, such as by an email, whenever a selected system-registered loan originator has uploaded a new loan to the system. In one embodiment of the system, the investor would be notified immediately upon a newly uploaded loan. In another embodiment of the system, the investor would be notified on a daily, weekly or monthly basis, with each such notification containing information about the loans uploaded by a selected loan originator during that time period with the frequency of notifications be selected by the investor. Such communications may aid the system-register investor by notifying it whenever a preferred loan originator has uploaded new loans for purchase so that it can more quickly purchase loans on the system from its preferred loan originators. While an embodiment of the invention allows for investors to select such communications settings, the present invention need not require this feature.

Decision block 201 shows a system-registered investor selecting either to purchase one or more syndication of loans directly from system-registered loan originators (“primary”) or from other system-registered investors, either by direct sale or by bidding in an auction, who have already purchased a portion of a loan on the system. As such, decision block 201 is split into three components: “direct sale” and “auction” from another investor, and “primary” from the original loan originator. Block 202 may begin the process for the primary market for purchasing a syndicated loan directly from the original loan originator. Blocks 210 and 214 begin the process for purchasing a syndicated loan directly from another investor either by direct sale (block 214) or an auction (block 210). Each of these sub-processes is discussed below.

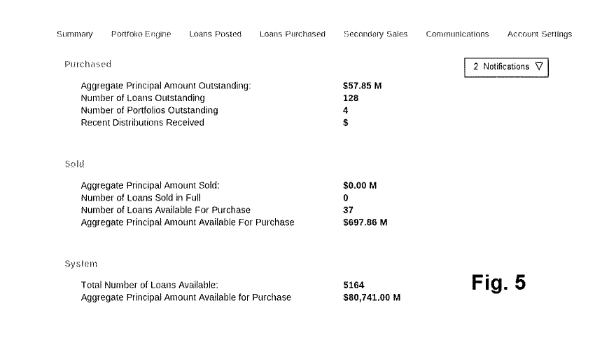

As mentioned above, if an investor wishes to purchase a syndicated loan directly from the original loan originator on the primary market, the method may proceed from block 201 to block 202. Block 202 illustrates a system-registered investor searching on the third party's system by means of an algorithm the available loans for syndication by various parameters, including, for example, certain loan metrics including the type of loan, interest rate and type, such as fixed or floating (by means of various benchmarks such as the PRIME or the London Interbank Overnight Rate, or LIBOR,), maturity, origination date, amortization, if any, principal, industrial sector, whether secured, guaranteed, type of collateral, location of collateral, and certain loan originator metrics, including historical default rates, including percentage or amount of performing loans, current loans, “slow pay” loans, delinquent loans, i.e., whether the borrower is 30, 60, 90 days or more delinquent in paying amounts owed as scheduled (including the severity of delinquency), rates of return, geography, institution type, such as bank, credit union, or whether the loan originator is a community development organization, including whether it is a certified community development financial institution or a minority depository institution, and certain “social proofing” or “popularity” concepts. Social proofing or popularity concepts may include the relative interest by investors in the loan originator as compared to other loan originators on the third party's system such as the relative number of investors that have purchased loans from the loan originator, the percentage of available loans that have been purchased, the average or median percentage purchased of loans available for purchase and other indications of interest by investors. This may be performed by certain means, including by comparing how many investors choose to receive updates on the availability of loans for purchase from that loan originator. Examples of the search graphical interface are illustrated and discussed below with regard to FIGS. 5-15.

System-registered investors may also search for a basket of loans (e.g., a plurality of loans) that meet her requirements or search parameters in addition to searching for individual loans. In an embodiment of the invention, when performing a search for a basket of loans on the third party's system, investors can additionally set parameters on the basket of loans such as limiting the concentration any one loan or loan originator may have in the fund and the maximum position the fund may have in a given loan or a loan originator, for example, having no more than 5% of any loan included in the basket of loans and that no portion of any loan be more than 10% of the aggregate principal amount of all the loans in the basket of loans. In one embodiment of the system, when an investor is searching for basket of loans, the system will automatically provide, to the extent available, series of different baskets of loans that meet the requirements for the loans and loan originators. In an embodiment of the system, the third party's system will return various baskets of loans prioritizing, within the investor selected criteria, which search metric is most important to least important as set by the investor, such as maximizing for interest rate. In one embodiment of the system, the returned basket of loans may be default to provide a diverse set of loans such as seeking to provide, to the extent available, a large number of loans that all meet the criteria selected rather than purchasing a large portion of a few loans.

After the search parameters are entered into the graphical user interface by the investors, a query is sent to the system. The third party system's server then parses the query and searches the third party system's database. The search results are then obtained and sent to the investor using the graphical user interface on the investor's computer.

Block 203 illustrates a system-registered investor reviewing the results of its search. In an embodiment of the invention, the third party's system displays a list of loans or a series of basket of loans that meet the investor chosen search criteria. In an embodiment of the invention, the third party's system also may display the results of the search in order of importance with the importance of each criteria being determined by the investor. For example, in the case of a basket of loans, if a range of interest rates are selected and a range of maturities are selected and the investor informs the system that the interest rate range is of greater importance than the maturity date range, then in the event that the system is able to return more than one basket of loans that meet all of the criteria, the first basket of loans in the list would be the basket that maximize the interest rate range and the second basket of loans would be the basket that maximized the maturity range. While an embodiment of the invention allows for ordering the search results by importance, the present invention need not be so limited.

When the investor locates loans or baskets of loans of interest using the system, the investor can review the loans, including the “loan file” or any of the individual loans underlying a basket of loans to determine whether the investor will invest in such loans. For example, the investor can select a loan or a basket of loans to obtain the particular details or loan information about a particular loan (or each particular loan in a basket of loans). For example, these details may be the type of loan, interest rate and type, maturity, origination date, amortization rate, if any, and principal as well as the supporting documentation for the loan. Additionally, when reviewing such loans, the investor may also review metrics regarding the loan originator for each particular loan, including certain loan originator metrics, including historical default rates including percentage or amount of performing loans, current loans, “slow pay” loans, delinquent loans, i.e., whether the borrower is 30, 60, 90 days or more delinquent in paying amounts owed as scheduled (including the severity of delinquency), rates of return, geography, and “social proofing” or “popularity” concepts. The third party's system may provide other information about the loan originator or loan. For example, the investor may review the loan file associated with such loan(s), or any other information that an investor would prefer to learn about the loan or the third party's system could provide information or connect the investor to other information about the loan originator such as reports prepared for or by government agencies such as the Federal Deposit Insurance Corporation (FDIC) or by private data information companies.

Block 204 illustrates a system-registered investor editing the results of his search (also referred to as “portfolio”). For example, an investor may edit the result of his search by removing particular loans from a basket of loans. In an embodiment of the invention, the investor is able to review, when searching for a basket of loans, each loan in the basket and may choose to remove any particular loan from the basket of loans. At this point, the basket of loans is just a selection of loans that the investor is interested in and has yet to purchase. As such, the investor is able to select which loans the investor wishes to purchase, if any.

Decision block 205 illustrates a system-registered investor determining whether to purchase the loan or basket of loans from its search results or choosing to run another search. If the investor chooses not to purchase the loans, the method may end or continue back to block 202 and start the search over. Otherwise, if the investor chooses to purchase the loans, the method may continue to block 206.

Block 206 illustrates a system-registered investor purchasing a loan or a basket of loans on the third party's system with the third party's system receiving and then distributing the proceeds from that purchase to (i) each system-registered loan originator that uploaded a purchased loan in the event of a primary market purchase; or (ii) to the investor that is selling the loan or basket of loans in the event of a secondary market purchase. In an embodiment of the third party's system, this transfer would occur on the third party's system by means of an ACH transfer or by other means.

Block 207 illustrates a system-registered investor receiving money, such as interest and principal, from system-registered loan originators with respect to the syndicated loans when payments are made by the borrower to the loan originator. In an embodiment of the system, these payment transfers would occur by ACH or by other means. As such, the borrower pays the investor indirectly through the third party system (or in another embodiment, through the loan originator).

Block 208 illustrates a system-registered investor receiving updated loan information on purchased loans from time to time as the system-registered loan originator updates information on the loans. For example, an investor may decide to review the status of the basket of loans or a loan purchased on the third party's system including the remaining outstanding principal balance of the loan. This principal balance may change as the borrower continues to make payments. Other information about the loan may also be updated, such as a changing interest rate, updated list of syndicated investors, and any other information relating to the loan. While an embodiment of the invention allows for loan originators to update loan information and for investors to review the updates, the ability to do so is not a limitation on the present invention.

Decision block 209 shows a system-registered investor determining whether to place loans or basket of loans or various portions of baskets of loans he/she has purchased on the system for sale to other system-registered investors. For example, a first investor could make available for purchase to other system-registered investors a single loan that the first investor has purchased, or the first investor could make available for purchase a single basket of loans for purchase or it could combine baskets (or portions of baskets) or individual loans to create a new basket of loans for other investors to purchase. If the decision in block 209 is that portions of loans are to be placed on the secondary market, the method may proceed to FIG. 3. Otherwise, the method may end, as illustrated in FIG. 2.

As discussed above, if the investor wishes to view auctions of loans or portions of loans, the method may continue to block 210. Block 210 illustrates a system-registered investor reviewing loans which are available for purchase by means of open auctions. In one embodiment of the system, the investor will be able to search for open auctions on the system's server and database by means of an algorithm similar to the algorithm for searching for loans in the primary market. In another embodiment of the system, the investor receives a list of all available auctions. Regardless, the list of auctions is retrieved from the system's database and is presented to the investor for review. Only the loans tagged as auctions will be part of the auction loans database, according to one embodiment, so that when an investor searches for auctions, only those loans identified as loans for auctions are returned to the searching investor.

Block 211 illustrates a system-registered investor reviewing loans available to purchase from other system-registered investors and placing a bid on the loans or basket of loans available for purchase from another system-registered investor. Any bid that is submitted is transmitted to from the investor to the system and entered into the system as a bid. Any amount of bids from any amount of system-registered investors can be received by the system for each loan on the auction block.

Block 212 illustrates whether the bid placed by the investor on the open auction was the winning bid. This is determined at the end of the auction (whether the auction is ended early or not) and if the investor at the time of auction close is the highest bidder, that investor is the “winner” of the auction and has committed to buying the loan. As such, the method then will direct the investor to purchase the loan at the last bid auction price in block 206. If the investor does not “win” the auction, the method returns to block 210 where the investor can again search and review open auctions to bid on any desired open auction.

For investors who want to purchase previously-purchased loans directly from other investors, the method continues to block 214 as mentioned above. In block 214, a system-registered investor receives a request for a direct sale from another investor on the system. This may occur by an investor locating a loan identified by an owner investor for direct sale (i.e., for sale not through the auction) and then sending a request to the owner investor to purchase the owner investor's loan. As described above, the owner investor's loan was previously purchased by the owner investor from the loan originator and wishes to now sale at least a portion of the loan. A direct sale is a sale whereby an investor directly contacts the owner investor with a request to purchase a loan or basket of loans with the requesting investor providing terms of the proposed purchase including the specific loan or loans for sale and price.

Decision block 215 illustrates an owner investor determining whether to accept the proposed terms of a direct sale of a loan or basket of loans from the requesting investor. If the proposed terms of a direct sale of a loan or basket of loans from the requesting investor are acceptable, the method may continue to block 206, where, as previously discussed, the loan may then be purchased according to the proposed terms and conditions (including price and amount).

Block 216 illustrates a system-registered investor receiving a request for an amendment or other action requiring a vote of the syndicate with respect to a particular loan. In this regard, the syndicate (i.e., the group of investors which own one or more portions of a particular loan) may have to vote on a proposed amendment to the loan, such as a change in interest, financial covenants or ratios such as maintaining a certain amount of revenue over a given period, or any other change in the terms and conditions of the loan.

As mentioned above with regard to block 209 of FIG. 2, if an investor of a loan wishes to sell the loan on a secondary market, the method may continue to FIG. 3 where the investor can sell the loan either by direct sale or auction. Decision block 301 illustrates a system-registered investor determining whether to sell loans or basket of loans by means of direct sale or by auction. If the investor wishes to hold a direct sale (i.e., sell the portion of a loan, portions of a basket of loans, etc. directly to another investor), the method may continue to block 306, which is discussed below. Otherwise, the method may continue to block 302 where the investor can hold an auction of the loan or portion of the loan.

Block 302 illustrates an owner investor setting the terms of an auction covering certain loan or basket of loans such as the term of the auction, a reserve minimum price that the investor is willing to sell the loan, whether to disclose such reserve minimum price of the auction, and any other terms of the auction. The various rules of the auction are not a limitation on the present invention.

Block 303 illustrates a system-registered investor initiating the auction so that other investors are able to review the loans or basket of loans that are available for purchase. The auction may be initiated by the investor posting the auction on a website and initiating a timer. Other ways of initiating the auction may also be possible. After the auction is initiated, other investors may bid on the loans or basket of loans whereby each bid is a promise to buy the loans or basket of loans if the auction closes with the investor's bid being the highest.

Decision Block 304 illustrates a system-registered investor determining whether any of the bids successfully met the terms of the auction. In an embodiment of the system, the system would automate the process of determining whether there was a winning bidder. The winning bidder may be one that has the highest bid at the time of the auction's end. The winning bidder is legally bound to buy the loans or basket of loans at the investor's last-submitted bid.

Block 305 illustrates the system-registered investors receiving the proceeds from a sale, either by auction or direct sale, from the other investor in consideration for the loans or basket of loans. In an embodiment of the third party's system, this transfer of the loans and the proceeds of the sale may happen by ACH or by other means that is managed by the third party, and the change of ownership of the loan or basket of loans would be managed by the third party's system. Thus, at this point the investor that owns the loans or basket of loans then transfers ownership thereof in response to the winning investor purchasing (e.g., transmitting funds) the loans or basket of loans.

If the sale is a direct sale (e.g., a sale directly to another investor from the investor owning the loan or basket of loans), the method may proceed to block 306, which illustrates a system-registered investor identifying another system-registered investor to sell a loan or basket of loans. The other investor may be input into the third party's system as the other investor that is going to buy the loan or basket of loans.

Block 307 illustrates a system-registered investor setting the terms of the sale, such a price for the loans or basket of loans for another system-registered investor to purchase. The other investor may then be bound by those terms to purchase the loan or basket of loans if accepted.

Block 308 illustrates a system-registered investor sending a notification to another system-registered investor that a loan or basket of loans is available for purchase and the terms of that purchase. Such notification may be sent via an electronic message over a network.

Decision Block 309 illustrates a system-registered investor determining whether to accept a direct sale of a loan or basket of loans from another system-registered investor. If the owner of the loans or basket of loans accepts the offer from the offerer investor, the method may proceed to block 305, which has been discussed above.

As mentioned above, the third party is a party other than the investors, the owner(s) of the loan, and the loan originator but which manages all payments therebetween as well as any amendments to loan documents. The third party also may perform one or more of the steps discussed above in FIGS. 1-3. In this regard, the third party hosts the data for searching by investors, hosts data for loan management, manages all payments by an investor when purchasing at least portion of a loan, manages all payments to transmit to owners of portions of the loan (syndicate), manages communication associated with loan document amendment, and performs any other tasks associated therewith. This allows the investors and loan originators to easily view the data for searching for loans to purchase (due diligence), manage their own portfolio of loans, and updating owned loan portfolios. The third party's system is in two-way communication over a network with investors and loan originators so that the third party can complete any of the above-mentioned tasks on behalf thereof.

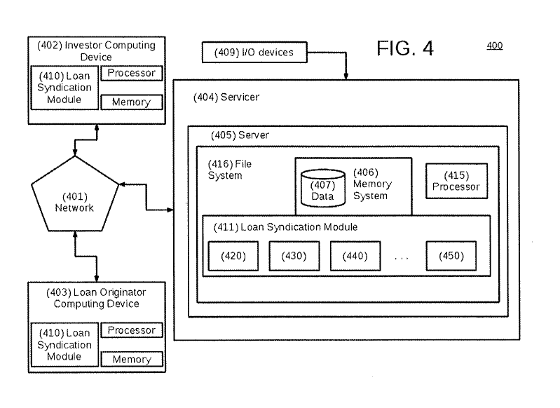

FIG. 4 is a block schematic diagram of a system 400 of an example of a method for loan syndication in accordance with an embodiment of the present invention. The system 400 may include a loan syndication module 410 operable on at least one investor's computer system 402, on a loan originator's computer system 403 or similar device of an investor, loan originator, user or client. Alternatively, or in addition to the loan syndication module 410 on the investor's computer system 402, loan originator's computer system 403 or other system, the system 400 may include a loan syndication module 411 operable on a server 405 (hereinafter “server loan syndication module 411”) and accessible by the user 402, 403 via a network 401. The above-discussed methods 100-300 of FIGS. 1-3 may be embodied in or performed by the loan syndication module 410 and/or the server loan syndication module 411. For example, the method 100 may be performed by the loan syndication module 410. In another embodiment of the invention, the method 100 may be performed by the server loan syndication module 411. In a further embodiment of the present invention, some of the features or functions of the methods 100, 200 and/or 300 may be performed by the loan syndication module 410 on a user's computer system 402, 403 and other features or functions of the methods 100, 200 and/or 300 may be performed on the server loan syndication module 411.

The computing devices 402, 403 may also include input and output devices, such as a display. The display may present applications for electronic communications with the server and/or input data into the computing devices 402, 403. Any GUIs associated with the loan syndication module 410, 411 and application may also be presented on the display.

The computing devices 402, 403 and the server 405 may also include one or more input devices, output devices or combination input and output device, collectively I/O devices. The I/O devices may include a keyboard, computer pointing device or similar means to control operation of applications and interaction features described herein. The I/O devices may also include disk drives or devices for reading computer media including computer-readable or computer-operable instructions.

It should be noted that while only one investor is illustrated in FIG. 4, multiple investors are connected to the network to connect to the third party's system 404. Likewise, while only one loan originator is illustrated in FIG. 4, loan originators are connected to the network to connect to the third party's system 404. Thus, the third party's system 404 is connected to multiple investors and loan originators over the network so that the methods of FIGS. 1-3 can be performed.

The system 400 includes a loan participation market servicer 404. The servicer 404 may include the server 405. The server 405 can be a webserver or the like connected to the investor computing device 402 and the loan originator computing device 403. Software for the syndication of the loans (hereinafter “loan participation market software” or just “loan participation market”) 408 as described by FIGS. 1, 2 and 3 operates or runs on the server 405 via the loan syndication module 411.

The loan syndication module 410 and/or 411 may be a self-contained system with embedded logic, decision making, state based operations and other functions that may operate in conjunction with collaborative applications, such as email, IM, blogs, wikis, phone calls, web conferencing and any other application which can be used to communicate with an intended recipient and/or perform operations for investing in syndicated loans. The self-contained system may also allow businesses, individuals (via 402, 403), services, locations, and the like to interact.

The loan syndication module 410 and/or 411 may be stored on a file system 416 or memory of the computer system 402, 403, and/or 405. The loan syndication module 410 and/or 411 may be accessed from the file system 416 and run on a processor 415 associated with the computer respective system.

It should be understood that the loan syndication module 411 may have multiple sub-modules, such as a communications module 420, a loan portion selection module 430, an auction/direct sale module 440, and any other modules 450 which could correspond to any of the steps of methods 100-300. The communications sub-module 420 of the loan syndication module 411 controls communications between the server 405 and other computing devices 402, 403 connected to the server 405 via the network 401. The communications module controls downloading and uploading date between the server 405 and other computing devices 402, 403 connected thereto. The communications module also performs any queries on the server and/or on a database 407. The communications module controls presentation of graphical user interfaces (GUIs) and content thereon that is presented to the computing devices 402, 403.

The loan portion selection module 430 of the loan syndication module 411 controls what loan or basket of loans will be selected by an investor to be posted for sell or sold. In this regard, the loan portion selection module is capable of selecting each loan or only a portion of each loan based on information provided in the database 407 on the loans. The portions of the loans may be selected together to create the basket of loans as discussed herein.

The auction/direct sale module of the loan syndication module 411 controls the aspects of the auctions or direct sale communications. The auction/direct sale module may initiate and end the auction and determines who the winner of the auction is. The auction/direct sale module may also initiate purchase payments instructions and effectuate payments from one party to another. Additionally, after purchasing has been completed, the auction/direct sale module may facilitate transfer of ownership of the purchased loan or basket of loans or perform any other post purchase processing of the loans.

The server loan syndication module 411 may further include GUIs. The server loan syndication module 411 may present one or more predetermined GUIs to permit the user (e.g., investors, loan originators, etc.) to define preferences and/or submit data and selections. The GUIs may be predetermined and/or presented in response to the user would like to interact with the system 400 in some manner, such as to perform a query, input information, upload data, download data, and the like. The predetermined GUIs may be generated by the server loan syndication module 411 and may be presented on the display of the computing devices 402, 403 of the user.

The loan syndication module 410, 411 includes computer-executable instructions that are embodied in a non-transitory computer-readable data medium 407 such as memory system 406. These computer-executable instructions perform any of the operations discussed herein such as the operations and method steps discussed above with regard to FIGS. 1, 2, and 3 as well as the GUIs of FIGS. 5-15. Database 407 may store all investor 402 and loan originator 403 inputted data. For example, all loans which may be invested in are uploaded from the loan originator computing device 403 to the server 405 which stores this information in database 407. In this regard, when the investor 402 queries the system (as mentioned above for block 202), the query is performed by the server 405 using the database 407. Additionally, the database 407 may have database entries for each investor which have been registered and possibly even entries for non-registered investors. Each registered investor is identified as registered in the database 407. The database 407 also may include database entries for loans, basket of loans, and/or portions thereof that are for sale on the market.

While the database 407 is illustrated in FIG. 4 as residing on the server 405, the database could alternatively be located at another location, such as a location where the server would access the data on the database 407 over the network 401.

The system 400 also includes input and output I/O devices 409. The I/O devices 409 are separate input and output devices or combination I/O devices that are coupled to the server 405 to provide an interface with the server 405 for programming purposes and to control operation of the server 405. Examples of the I/O devices 409 include a keyboard, pointing devices, display or monitor, disk drives, optical, mechanical, or infrared I/O devices or the like.

Investors 402, and loan originators 403 or other entity/user accesses the loan participation market 408 via a network 401, medium or the like, using a browser. Small loan originators 403 may include banks less than $10 billion in assets. As mentioned above, loan originators could be a bank or any other type of financial institution that issues loans. While FIG. 4 illustrates a loan originator 403 as a single block, this represents either a single loan originator or a plurality of loan originators. Similarly, while FIG. 4 illustrates an investor 402 as a single block, this represents either a single investor or a plurality of investors. Regardless, the investor has a computer that is connected to the network 301 and the investor connects with server 405 via a graphical user interface.

The GUIs may include an interface that allows the investor to input the various search parameters. These search parameters form a query which is sent to the server 405 of the servicer. The GUIs are presented on the investor's computer and also presents the search results from the server 405. The GUI also allows the investor to browse detailed information about the search results and loan portfolios.

The servicer 404 may be an entity that is a third party which is separate from the investor(s) and separate from the loan originators. In one embodiment, the servicer 404 is an intermediary between the investors and loan originators and performs the searching (using database 407) as discussed previously with regard to FIG. 2.

The network or medium 401 is any communication network or system including by way of example, dedicated communication lines, telephone networks, and wireless data transmission systems, two-way cable systems, and customized computer networks, interactive kiosk networks or the like. The network or medium 401 is the Internet or a private network, such as an intranet or the like according to some embodiments.

FIGS. 5-15 illustrate graphical user interfaces (“GUIs”) of a method for an initial or primary syndication of a loan and an example of a secondary market for the syndication of loans in accordance with an embodiment of the present invention. In this regard, the GUIS of FIGS. 5-15 illustrate GUIs that the system 400 may present to an investor and/or loan originator to perform one or more steps of methods 100-300 of FIGS. 1-3.

As illustrated in the GUIs of FIGS. 5-15, tabs extend across the top of the GUIs, including Summary, Portfolio Engine, Loans Posted, Loans Purchased, Secondary Sales, Communications, and Account Settings. Each of these tabs relate to different GUIs which perform various functions, including at least some of the method steps discussed in FIGS. 1-3.

FIG. 5 illustrates the “Summary” page of the users of the system 400. As illustrated, basic system information is provided for each user. First, the Summary tab lists information regarding loans purchased, including the aggregate principal amount outstanding, number of loans outstanding, the number of portfolio purchases outstanding and any recent distributions. Second, the Summary tab lists loans sold, including the aggregate principal amount of loans sold, the number of individual loans sold, the number of loans available for purchase and the aggregate principal amount of loans available for purchase. Third, the Summary tab lists system-wide information regarding the total number of loans available for purchase on the system and the aggregate principal amount available for purchase. Finally, the summary page provides notices to the user, including whether a purchased loan has a request for an amendment open or request to purchase a loan in a secondary market transaction is available.

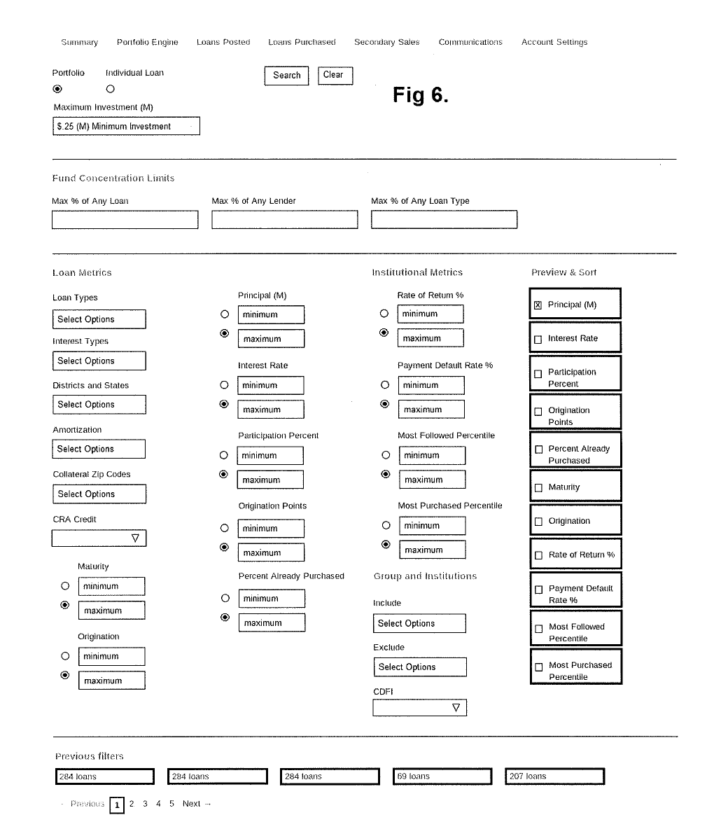

FIG. 6 illustrates the “Portfolio Engine” tab, which provides a GUI for investors to query the server for an individual or portfolio loans by various metrics including loan metrics such as loan types, interest type and rate, geography, principal amount, maturity date, participation rate, origination fees, and/or institutional metrics, such as an institution's historical rate of return and default rates or the “popularity” of a lending institution, such as on a relative basis how many investors are interested in purchasing loans from a lending institution or have purchased loans from a lending institution. For example, as illustrated, an investor can query the GUI in the “Portfolio Engine” tab for all portfolios that have a maximum investment of $25 million and so the investor inputs $25 million into the search box on the GUI of FIG. 6. The system 400 will then query the database 407 to return the loan originators or investors have less than $25 million worth of assets. In this regard, an investor can then attempt to purchase a syndicated loan of a relatively small size.

In one embodiment, the investor can search the database 407 by inputting parameters into the “Rate of Return” field, the “Payment Default Rate %” field, the “Most Followed Percentile” filed, and/or the “Most Purchased Percentile” field. The return rate and default rates relate to the historical performance of that lending institution with respect to loans posted on the system. This return rate and default rate for each lending institution may be stored on the database 407. For example, the investor may input into the “Rate of Return” field that any loans resulting from a search on the database be from lending institutions with a rate of return between 5 and 10 percent.

Similar to the “Rate of Return” field, the investor may input a minimum and maximum principal default rate (e.g., principal default rate could include all delinquent loans or only loans that have been foreclosed with a final payment insufficient to repay the loan in full or other means of determining principal default) into the “Payment Default Rate %” field and returning only loans from lending institutions on the database 407 within the specified parameters resident on the database 407 is returned to the investor.

With regard to the “Most Followed Percentile” filed and the “Most Purchased Percentile” field, these are examples of the popularity filtering criteria. In this regard, an investor may want to search lending institutions that are popular in certain respects. For example, some investors may want to see which lending institutions that other investors are following or which have had a lot of purchases relative to the other lending institutions. When an investor performs a searching using the popularity filtering fields, the popularity information is retrieved from the database 407. It is noted that the popularity filtering data is initially collected 407 by keeping track of all information related the popularity of a lending institution, such as increasing a database entry for each lending institution each time there is a purchase from that respective lending institution. Additionally, another database entry for each lending institution may be incremented when an investor adds the lending institution to his favorites, requests to electronically “follow” the lending institution, or some other way to keep track of the lending institution. When an investor performs a popularity search, the database entries for each lending institution are compared to determine the lending institutions within the investor's requested percentage. Then only the loans from those lending institutions are provided to the investor from the database when conducting searches.

While searching using a maximum investment limit, which is a parameter that can be used to limit the total principal amount to be invested or purchased in any portfolio of loans, other parameters can also be used to filter loans. For example, the “Portfolio Engine” page also allows the investor to limit the fund concentration, or proportion, of loans in a portfolio of loans from a single loan originator, or of a particular loan or loan type. Additionally, the search engine allows investors to “rank” the importance of different search criteria to maximize the criteria that investor finds most important.

Regardless, all of the searching criteria may be input in the GUI of FIG. 6 according to one embodiment. The system 400 then searches the database 407 to return all loans or portfolio of loans that meet such inputted criteria.

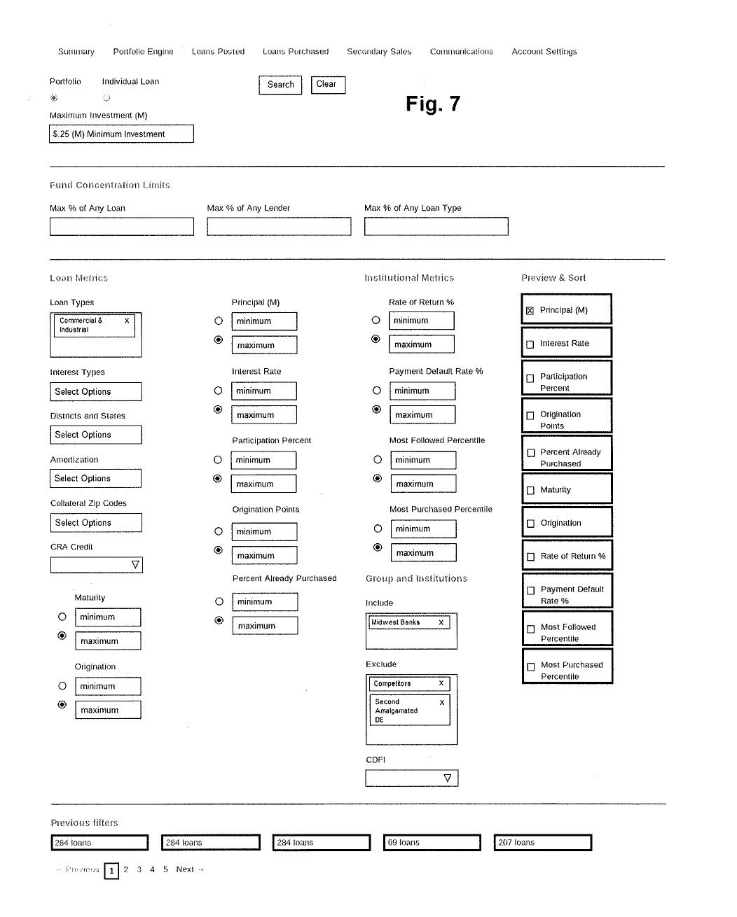

FIG. 7 illustrates an example of the GUI of FIG. 6 where additional criteria has been applied to the query parameters. For example, the user (e.g., investor) has selected that only Midwest Banks (a list of loan originators created by the investor) be included in the search and to exclude all competitors (another list generated by the investor) as well as a specific bank or investors (in this case the hypothetical bank of Second Amalgamated of DE). The user has also selected the filter that she only wants to see loan types of “Commercial & Industrial.”

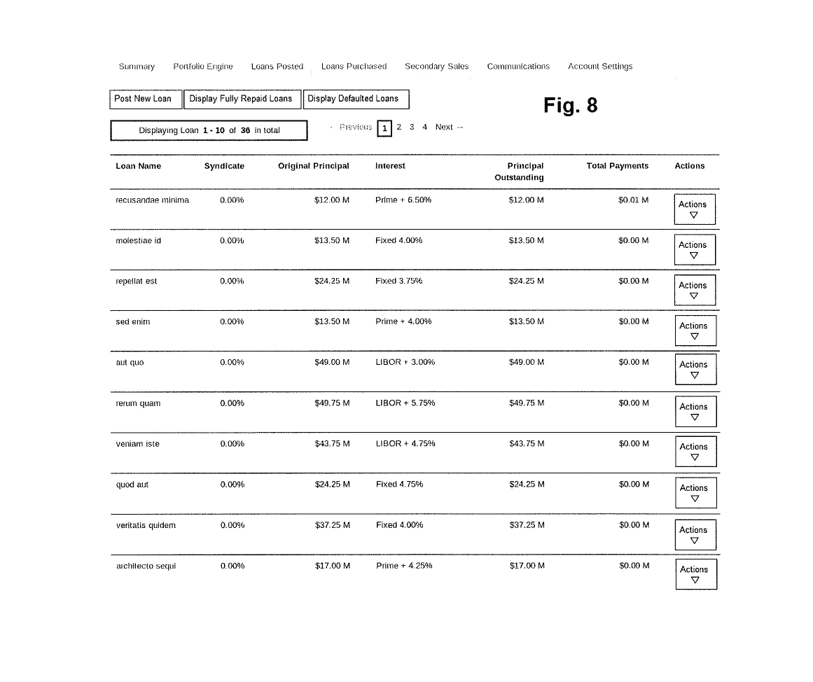

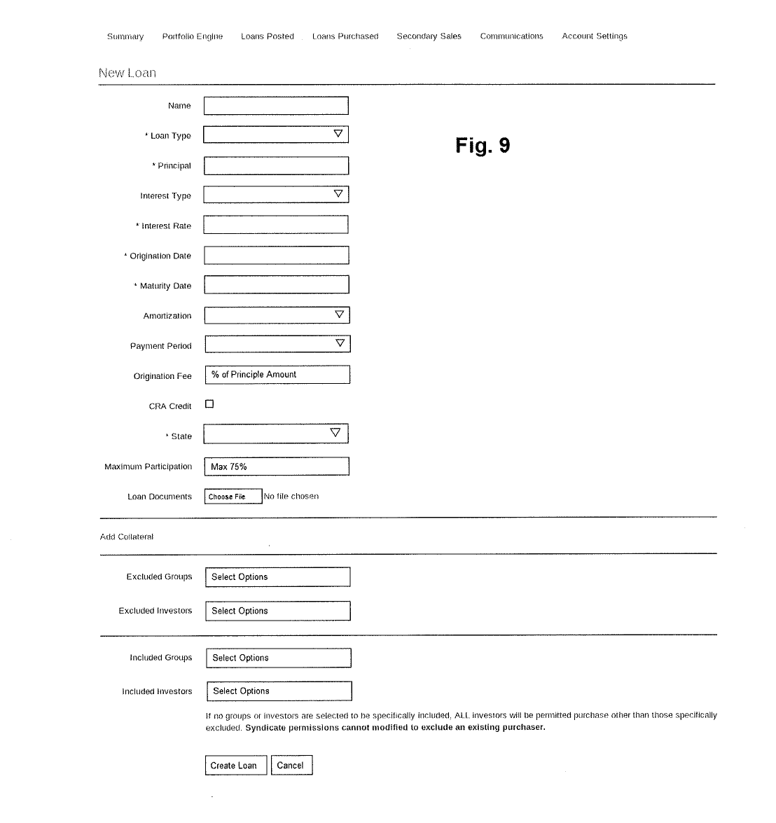

FIGS. 8-9 illustrate the “Loans Posted” tab. The “Loans Posted” GUIs provide, as illustrated in FIG. 8, basic information regarding each loan posted by the loan originator and enables the loan originator to take certain actions with respect to that loan, including informing the system of a borrower payment, checking or changing syndicate membership, or updating information regarding the loan file. This information is retrieved from the database 407 using a query on the GUI (and the GUI knows to search for information associated with the loan originator because the loan originator has logged into the system). As illustrated, FIG. 8 shows the loan name, syndicate percentage (which may refer to the percentage of the loan that has been sold or owned by another investor), the original principal, the loan's interest rate, the outstanding principal and the total payments on the loan.

Additionally, the loans posted page allows the loan originator take other actions, including reviewing previously fully repaid loans, view defaulted loans and post new loans for syndication. For example, FIG. 9 illustrates a GUI which is directed to allow the loan originator, investor or whoever owns the loan to post a new loan (in FIG. 8 the button “Post New Loan” was selected). As illustrated in FIG. 9, the user then may post a new loan for other investors (and other users) to view and optionally purchase (if appropriate). Information on the loan, including loan type, name, principal, interest type and rate, origination date, maturity date, amortization, payment period, origination fee, CRA credit, state where the loan is located, maximum participation amount, loan documents that should be uploaded, collateral information, excluded groups and/or individuals which are not able to view/purchase the loan, included groups and investor that can access information about the loan and/or purchase the loan. When this information is included, the user then creates the loan, which is then uploaded to the database 407 and indexed for future querying. The loan may be syndicated so that only a portion of the loan may be purchased by an investor, regardless of the size of the loan. Thus, the “post new loan” page feature provides a means for originating banks to post loans for syndication and manage the potential syndicate members by either including or excluding certain potential investors from the syndicate.

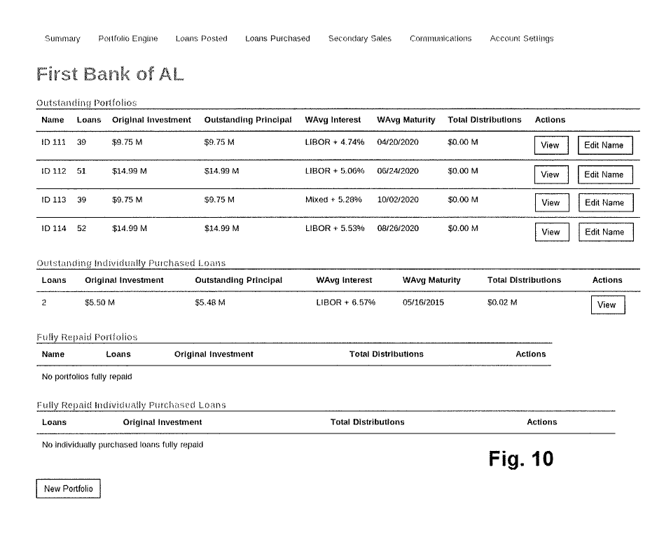

The “Loans Purchased” GUI, which provides a means for a purchaser to review an investor's purchases of loans and loan portfolios, whether the loans continue to be outstanding or have been repaid in full. For example, FIG. 10 illustrates information on a hypothetical First Bank of Alabama, including the outstanding portfolios (or basket of loans) and individual loans and fully repaid portfolios and individual loans associated with the hypothetical bank of First Bank of Alabama.

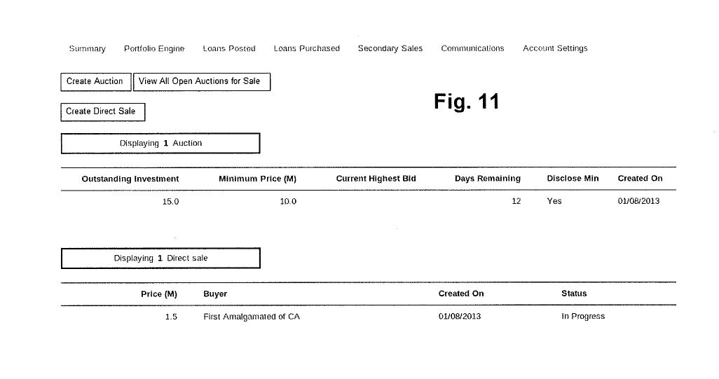

FIG. 11 illustrates the “Secondary Sales” GUI, which provides a means for purchasers of loans to re-sell their loans in a secondary market transaction to other purchasers and investors. Sales to other investors can occur by two means, first, by allowing a purchaser to sell directly to another purchaser or, second, by allowing the purchaser to create an auction for investors to bid on the loans placed for sale, as previously discussed. FIG. 11 illustrates all open auctions for sale and there is one auction of a loan in progress and one direct sale of a loan in progress. The user is also provided options to create a new auction or a new direct sale.

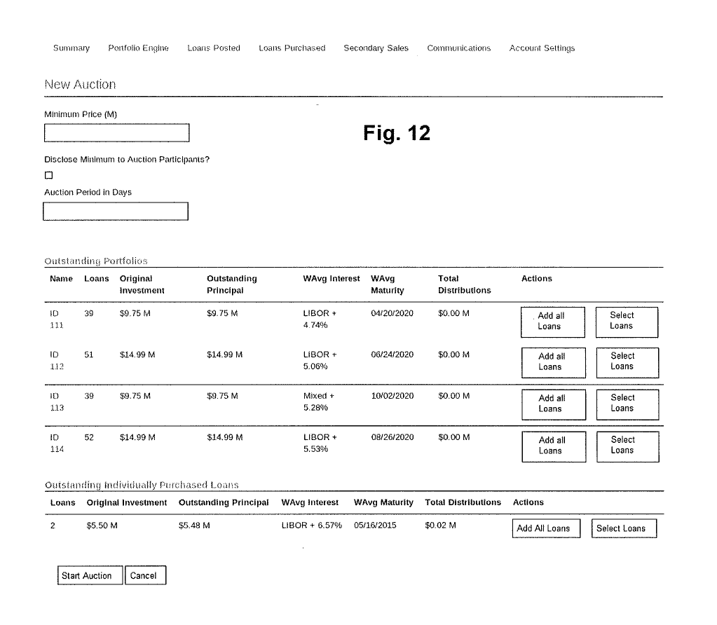

FIG. 12 illustrates the “Create Auction” GUI, which provides a means for a purchaser of a loan or portfolio of loans to setup a new auction to allow other investors to bid for and purchase loans or portfolio of loans from that purchaser. The original purchaser can divide or aggregate loans it holds in any manner it desires and place that aggregation of loans for auction. Thus, a syndicated set of loans of any price amount can then be sold on an auction on a website using the server 405 of the system 400 of FIG. 4. Referring back to FIG. 12, various information may be input to create the auction including the minimum price, the period of days to hold the auction, and options to select which loans or portfolio (or basket) of loans the user wishes to add to the auction.

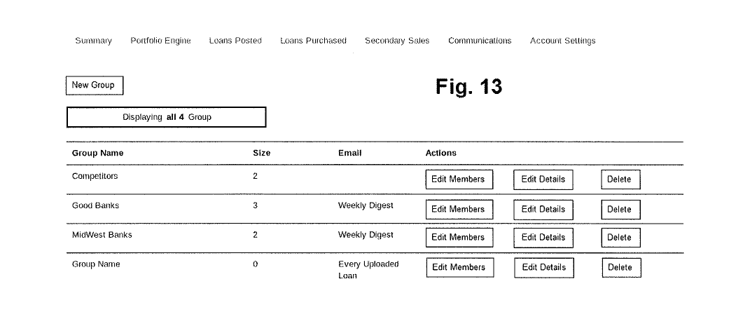

FIG. 13 illustrates the “Communications” GUI, which provides a means for a user to set its communication settings which include creating various “groups” of investors or loan originators or both. Users can then use those groups as a basis to exclude or include them for purposes of syndication management, for searching for new loans, or for receiving information regarding the posting of new loans from time to time from the system automatically.

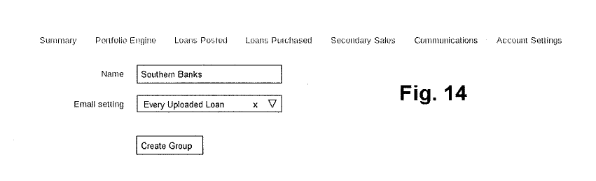

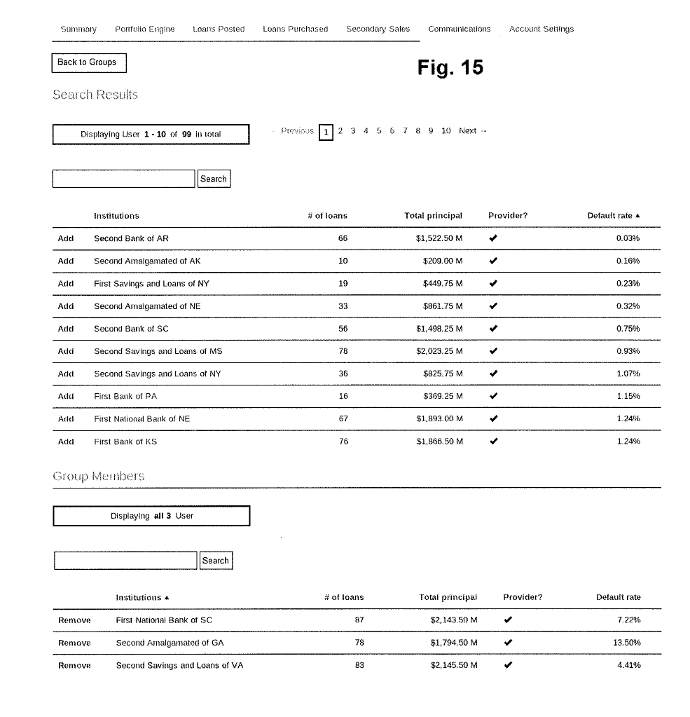

FIG. 14 illustrates a GUI that allows the user to create a group name and identify whether, and how often, the system 400 should update the user regarding information about loans posting from users within the group. As illustrated in the embodiment of FIG. 14, the user wishes to be notified whenever a hypothetical Southern Banks group has uploaded every loan. Thus, every time each of the hypothetical “Southern Banks” group uploads a loan to the database 407 of the system 400, the user is sent a message (e.g., email) to be notified of such upload in case the user wishes to immediately purchase the uploaded loan or basket of loans, whether syndicated or not. FIG. 15 illustrates the user adding the specific hypothetical banks to the “Southern Banks” group and options to add additional hypothetical banks to the group.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to embodiments of the invention in the form disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various embodiments with various modifications as are suited to the particular use contemplated.

Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

What is claimed is:

1. A method is disclosed for facilitating the syndication of loans by
receiving, via a computing device over a network, upload details of originated loans and lending institutions that own the originated loans;
storing the upload details of the originated loan and lending institutions in a database;
determining metrics of the lending institutions stored in the database;
receiving query terms associated with the metrics to query the database so that a user can determine if the user wishes to purchase either at least a portion of a single loan or a portfolio of loans;
querying the database with the requested query terms and returning a list that satisfies the search criteria and that are owned by an entity other than the user;
receiving a selection of at least one loan from the list; and
facilitating the transfer ownership of at least one selected loan from the owning entity to another entity.

2. The method of claim 1,
wherein the receiving query terms comprises receiving an indication that the user wishes to only purchase a first portion of the loan; and
wherein the receiving a selection comprises receiving a selection that the user wishes to purchase the first portion of the loan.

3. The method of claim 1, wherein the receiving query terms occurs over a network so that the user submits the query via a website over a network for receipt by a server that is also connected to the network.

4. The method of claim 1, wherein the query terms comprises a level of popularity of a lending institution among a plurality of lending institutions, wherein information of each of the plurality of lending institutions are stored in the database.

5. The method of claim 4, wherein the level of popularity for each lending institution relates to how many loans each respective lending institution has sold.

6. The method of claim 4, wherein the level of popularity for each lending institution relates to a calculation for each respective lending institution as to how many times the lending institution has been added to users' accounts so that users are allowed to follow the lending institution.

7. The method of claim 1, wherein the query terms comprises an historical rate of return of a lending institution.

8. The method of claim 1, wherein the query terms comprises an historical loan default rate of a lending institution.

9. A method comprising:
receiving an indication from a user that the user wishes to list a loan or portfolio of loans for sale on a server over a network;
determining, by a computing device using a database, whether the user is an investor or a loan originator;
presenting options to the user to post at least a portion of the loan or portfolio of loans for sell on the server;
receiving a selection of one of the options from the user;
receiving the at least a portion of the loan or portfolio of loans that the user wishes to sell using the server;
publishing, using the server, the at least a portion of the loan or portfolio of loans that the user has to sell; and
receiving a purchase request from an investor to purchase the at least a portion of the loan or portfolio of loans that the server published for sale.

10. The method of claim 9, further comprising forwarding the purchase request to the user for approval.

11. The method of claim 10, further comprising facilitating a purchase of the at least a portion of the loan or portfolio of loans from the user to the investor in response to the user approving of the purchase request.

12. The method of claim 9, further comprising
receiving a request, at the server over a network, from the investor for data from the database about any loans or portfolio of loans that the user owns; and
querying the database for information associated with the user comprising what loans and portfolio of loans that the user owns; and
transmitting to the investor results from the query.

13. The method of claim 9, further comprising:
determining whether the investor is registered in the database; and
in response to determining that the investor is registered, allowing the investor to access information on the database.

14. The method of claim 13, further comprising determining if the investor wishes to sell at least a portion of a loan or portfolio of loans as a primary, direct or auction sale.

15. The method of claim 14 further comprising:
in response to receiving an indication that the investor wishes to sell the at least a portion of a loan or portfolio of loans as a primary sale, allowing the investor to query the database for the at least a portion of a loan or portfolio of loans of the user; and
receiving a first selection of which loans or portions of loans of the at least a portion of a loan or portfolio of loans the investor wishes to purchase;
wherein the receiving a purchase request comprises sending the user a purchase request for the first selection by the investor.

16. The method of claim 14, further comprising:
in response to receiving an indication that the investor wishes to sell the at least a portion of a loan or portfolio of loans as a direct sale, transmitting a purchase request from the investor to the user for the a selected portion of the at least a portion of a loan or portfolio of loans;
transmitting to the investor an indication whether the user has accepted the purchase request.

17. The method of claim 14, further comprising:
in response to receiving an indication that the investor wishes to sell the at least a portion of a loan or portfolio of loans as an auction sale, providing the investor with a list of auctions;
receiving a bid from the investor for the at least a portion a loan or portfolio of loans;
transmitting a message confirming that the investor has won the auction in response to the bid being accepted at an end of the auction.

18. The method of claim 9, further comprising receiving a request by the investor to resell, on the server, the at least a portion of the loan or portfolio of loans after the investor has purchased the at least a portion of the loan or portfolio of loans.

19. The method of claim 9, wherein the at least a portion of the loan or portfolio of loans comprises only a portion of a loan such that the at least a portion of the loan or portfolio of loans comprises a syndicated loan.

20. A system comprising:
a database communicatively connected to a computing device over a network;
a server communicatively connected to the computing device over the network;
a module, when executed by a processor on the server causes the server to perform a method, the method comprising:
receiving upload details of an originated loan;
storing the upload details in the database;
receiving query terms from a user to query the database so that a user can determine if the user wishes to purchase either at least a portion of a single loan or portions of a portfolio of loans;
querying the database with the requested query terms and returning a list of loans or a portfolios of loans that satisfy the search criteria and that are owned by an entity other than the user; and
receiving a selection of a selected loan from the user so that the user can purchase the selected loan in order for ownership of the selected loan to transfer from the owning entity an entity associated with the user.
